(19) United States
(12) Patent Application Publication
(10) Pub. No.: US 2002/0130967 A1
(43) Pub. Date: Sep. 19, 2002

(54) Multi-point, concurrent, video display system using relatively inexpensive, closed vehicles

(76) Inventor: Michael Sweetser, Morgan City, LA (US)

Correspondence Address: C. Emmett Pugh, Pugh/Associates, Patent and Trademark Attorneys, 82 N. Main St., Suffield, CT, 06078-2102, US

(21) Appl. No.: 09/751,603

(22) Filed: Dec. 29, 2000

(51) Int. Cl. H04N 5/66

(52) U.S. Cl. 348/383

(57) ABSTRACT

A relatively short body (e.g. 12′ length), mobile, closed body vehicle (e.g., a pullable, closed trailer 100 (FIGS. 2 -4), van 200 (FIGS. 6 & 7) or closed truck 300 (FIGS. 8 & 9) with a box-like body (101/201/301/501) preferably of a standard, readily available type, which is modified to have wall openings made, having preferably a dynamic video display (115/215/315/515) on each of its sides and rear, in which preferably the video signal to be display originates from, for example, the “Internet” (2) and is supplied to the vehicle via, for example, a satellite hook-up (1& 103/203/303/505) or, alternatively, via a hard-wired (504) or a wireless “connection.” A multi-point, video display system (FIG. 1) uses a multiple number of such vehicles geographically dispersed at various locations, each preferably with its own connection to, for example, the “Internet”, or more preferably using a two-way, geosynchronous satellite hook-up, allowing for the concurrent, co-ordinated display of the same video signal at the geographically spaced or dispersed locations in a very cost effective manner. Such an approach allows, for example, the “live” (or recorded) presentation of, for example, a political speech or announcement or a sporting event or political or business event or other event or advertising campaign of a geographically dispersed interest. Each video display takes up a percentage of at least about fifteen (15%) percent or greater of each side wall's area.

### TECHNICAL FIELD

The present invention relates to a video display, system in which video display screens on the sides of a mobile, wheeled vehicle are used to display changeable video signals for viewing outside of the vehicle, in which the signals can be computer generated within the vehicle or received by hard-wired or wireless or satellite signals emanating, for example, from the “Internet,” that is the global, world-wide information network. The mobile, wheeled vehicle used preferably is one in which a standard, relatively small bed, relatively inexpensive, readily available vehicle (e.g., an un-motorized, closed body trailer, a motorized, closed van, or a closed body truck, etc.) is used with only relatively minor modifications made to it (e.g., a limited size, rectangular cut-out in each side wall and/or rear wall) to accommodate a rear projection TV or video display panel on each side). Additionally, other aspects of the invention relate to a multi-point, concurrent video display system, e.g., for advertising, in which multiple ones of the mobile, video display vehicles are positioned at geographically spaced locations, for, for example, simultaneously or concurrently displaying the same video signals in a coordinated manner, or for concurrently displaying different video signals, as may be desired.

### BACKGROUND ART

It is known broadly to use mobile vehicles to display, for example, advertising material or other information.

The following table lists several patents which may be of general background interest to the present invention.

| Patent No. | Patentee(s) | Date |
|---|---|---|
| 4,110,792 | Long et al | 1978/08/29 |
| 4,495,719 | Futatsuishi et al | 1985/01/29 |
| 4,701,627 | Gambuit et al | 1987/19/20 |
| 4,782,615 | Futatsuishi et al | 1988/11/08 |
| 5,005,893 | McCray | 1991/04/09 |
| 5,083,826 | McCray | 1992/01/28 |
| 5,263,756 | Gaspar | 1993/11/23 |
| 5,415,451 | Stanton | 1995/05/16 |
| 5,507,109 | Rinzler | 1996/04/16 |
| 5,918,924 | Cowan | 1999/07/06 |

For example, it is known broadly to display advertising or other types of signs or displays on the sides of various, wheeled vehicles; note the '719, '615, '893, '826, '756, '451, '109 and '924 patents, while the '792 patent displays a video signal on a very large screen raised up above its wheeled vehicle for wider viewing at the location of the video signal's origination, and the '627 patent uses an internally located, projection TV video screen directed rearwardly to be viewed through its van's open rear doors.

With respect to the mobile, wheeled vehicle used in the preferred embodiment of the present invention, the '627 patent and the '756 patents are possibly the more pertinent.

The Gambuti et al '627 patent is directed to a “mobile display apparatus” (a closed van) in which a projection TV set is located completely inside the van with its single, video display screen positioned to display its images to the rear through the rear doors of the van when the doors are open. This approach greatly limits the viewing scope or coverage of the display, limiting the viewing audience only to those in the rear in a relatively narrow field of view and cannot be used practically for display while the vehicle is in motion.

Also, the need to open up the doors for display operation exposes the interior of the van to the ambient during display operations, a distinct disadvantage when in inclement weather, such as cold, windy weather or rain or snow, etc. This “open door” arrangement likewise raises security issues, requiring a watchful operator to be ever present and vigilant to unauthorized personnel gaining access to the van's interior where, for example, all of the expensive, highly desirable, electronic equipment is located. To gain access, apparently one merely needs to go through the open doors and remove some black canvas sheeting (400 of FIG. 9, col. 3, lines 45-57) to gain access to all of the electronic equipment.

In contrast, the present invention in its preferred embodiment preferably uses a closed body vehicle with side wall cut-outs sized to match the TV or video display screen, with no significant, if any, gaps between the side screens and the remaining vehicle walls, providing reasonable security, even allowing an operator to position the vehicle, start-up the equipment to display the desired video signal, and even leave the vehicle for, for example, a lunch break or the like, with the standard vehicle doors locked, thereby still maintaining reasonable security from theft. Also, in the present invention, with operation allowed with all doors closed, adverse weather conditions that might damage the electronic equipment in the '627 patent or make discomfort for the operator in the '627 patent is not a significant factor in the present invention.

The Gaspar '756 patent is directed to a closed body “advertising vehicle” in which racks of multiple TVs (e.g., sixteen TVs in each side wall rack) are located in the side wall areas of the vehicle. This approach, involving in the exemplary embodiment a total of thirty-two! TV sets, generates a very large amount of heat, requiring the use of a relatively expensive, high energy usage, separate air conditioner (7 of FIG. 2). Additionally, the large TV racks takes up almost all of the previously existing wall areas, estimated to be over eighty (80%) percent of the total side wall area, raising problems of structural integrity in the vehicle body requiring substantial restructuring of the body's walls and roof, and leaving no room for a side door or additional areas for signage or the like.

Again this is significantly different from the preferred approach of the vehicle aspects of the present invention.

Additionally, with respect to all of the foregoing patents, in the preferred embodiment of the present invention, the advertising or video display aspects include a multiple-point arrangement in which multiple, mobile, video display vehicles are geographically dispersed (typically miles away from at least some), each using, for example, a satellite feed or wireless-feed, “internet” signal to, for example, concurrently display the same video signals at each geographically spaced location preferably in coordination with each other.

With respect to the McCray '893 & '826 patents, the McCray approach is directed to the use of a long bed trailer having an unusually configured, indicia display superstructure of some complexity mounted on the bed of the trailer, in which the side walls of the superstructure are each canted inwardly toward the cab and canted inwardly toward their tops, forming trapezoidal configurations at their combined top and front and rear. External lights are used to illuminate the non-video indicia displays that take up the full sides of the superstructure and require a change out of panels to change the indicia display. The McCray approach appears to be primarily designed to be viewed by people located in front of and to the sides of the trailer as the driver is driving down the road. This approach is in contrast to the preferred, relatively inexpensive, relatively short, enclosed body vehicle of the present invention, which generally or substantially has a rectangular or box-like configuration to its closed body as used in “off-the-shelf,” standard vehicles, in which there are side video displays which still leave a substantial portion of the side walls of the vehicle in place and are often, if not more often, used for static (i.e., vehicle is parked) display of the preferably constantly and instantly changeable, video signals.

With respect to the Long et al '792 patent, it is directed to a “mobile information display system” which is transported to the site of a sports or entertainment event and then erected way above the vehicle to provide a large screen display of video images produced by a live TV camera so that even those members of the audience who are unable to obtain a full view of the actual activity may see the field action as well as instant replays on the erected vehicle screen. This again is a very expensive, highly customized type vehicle requiring a complex, expensive erection subsystem located on the bed of a long bed trailer (note, e.g., FIGS. 2-4). The difficulty of movement and placement of the large, McCray vehicle and its great expense and possible need for multiple operators, make it, not only very different from the basically “off-the-shelf,” relatively inexpensive, closed body vehicle of the present invention whose body only needs to have limited, rectangular sections cut out from each side wall, the McCray vehicle also is not practical in the multi-point advertising aspects of the present invention.

### GENERAL SUMMARY DISCUSSION OF INVENTION

Thus, the present invention in its preferred, vehicle embodiment aspects is directed to a relatively short body [for example, less than about twelve (12′) feet in body length], mobile, enclosed body vehicle with a box-like body preferably of a standard, readily available type having preferably a discrete video display on at least one side of its enclosed body and preferably physically separate video displays on both sides, if not also to the rear of the vehicle body and possibly the front, if so desired, in which the vehicle is relatively inexpensive [only about thirty-five thousand ($35,000.00) dollars or less]. Preferably the fully digital, video signal to be displayed to originates from, for example, the “Internet” or one or more land-based server(s) and is digitally supplied to the vehicle via, for example, preferably a two-way satellite hook-up, or, alternatively, via at least in part a hard-wired or a wireless “connection.”

Also, the present invention in its preferred, multi-point, dynamic video display or advertising system embodiment aspects is directed to the use of a multiple number of such vehicles geographically dispersed at various locations, each preferably with its own connection to a digital video server, for example, via in part possibly the “Internet,” and more preferably using a satellite hook-up having two way communications capabilities, allowing for the concurrent, coordinated display of the same, dynamic digital video signal at the geographically spaced or dispersed locations. Such an approach allows, for example, the “live” (or recorded) presentation of, for example, a political speech or announcement or a sporting event or political or business event or other event or advertising campaign of a geographically dispersed interest. In using the term “geographically dispersed” herein is directed to a system in which at least one of the multi-points is spaced from another at least a number of miles and more typically at least many miles, while some of the multi-points could be located closer to one another or even be adjacent to one another.

It is thus an object of one aspect of the invention to provide a relatively inexpensive video display vehicle preferably using a relatively short body, mobile, wheeled, enclosed, metal body vehicle with a box-like body preferably of a standard, readily available, “off-the-shelf” type.

It is a further object in the preferred embodiment of the present invention in another, independent aspect of the invention to use such a vehicle and provide a discrete video display on at least one side of its enclosed body and preferably physically separate video displays on each side, requiring only the cut-out of a limited section in each side wall of the enclosed body vehicle, with the cut-out designed to fit to or otherwise be compatible with the screen size of the video display to be used.

It is a further object of the present invention in another, independent aspect of the invention, to provide a multi-point dynamic video display or advertising system directed to the use of a multiple number of video display vehicles geographically dispersed at various locations, each preferably with its own connection to, for example, possibly the “Internet” to a digital video server located at least miles (more typically many miles) or more away, more preferably using a two way satellite hook-up, allowing for the concurrent, co-ordinated display of the same digital video signal at the geographically spaced or dispersed locations. Such an approach allows, for example, the “live” (or recorded) presentation of, for example, a political speech or announcement or a sporting event or political or business event or other event or advertising campaign of a geographically dispersed interest.

In connection with the invention's vehicle aspects individual, dynamic video displays are preferably located separately on at least the two sides and possibly also the rear of the enclosed vehicle body, which has locked door access into its interior, with the dynamic displays being viewable through wall cut-outs in the standard, “off-the-shelf” closed body, wheeled vehicles, preferably at least alternatively powered by long-lasting batteries, with the vehicles preferably having “Internet” access via a hard-wired, wireless or satellite connection. Each of the video displays, when at least in the form of a rear projection TV, preferably is separately mounted on a wheeled dolly, along preferably the computer and other electronic equipment, for easy loading and unloading of them with respect to the vehicle. Additionally, it is preferred that only a single video display is located on a side, with the screen taking up from about ten (10%) percent to about twenty-one (21%) percent or greater of each of the total side wall areas, with there preferably being only one video display screen per side. A particularly preferred embodiment has a percentage of about fifteen to sixteen (15 -16%) percent or greater, that is, at least about fifteen (15%) percent.

Although a multiple vehicle system is preferred, an individual vehicle in accordance with the present invention can also act alone, as part of, for example, a single vehicle display system, displaying, for example, advertising or information displays using a web site as a content source for the dynamic displays. An example of this would be a vehicle located at a computer trade show displaying selected content from a computer software or hardware company's web site. Additionally, although the use of the Internet as the content source or delivery system for the video content for display is preferred, alternatively, totally internally contained content could be used, utilizing, for example, an on-board computer sending video signals from the computer's hard drive or supplemental storage devices, a DVD, laser disk, or VHS tape, etc., as the content source.

Some other, exemplary preferred features include:

The vehicle's electronics are preferably are powered by “marine” type batteries, producing at least about two hundred (200) amp hours, with the exemplary battery producing about two hundred and twenty-five (225) amp hours. They can sustain a charge of, for example, eight working hours. The batteries are charged off of the alternator while the vehicle is running.

The use of such batteries allows the elimination of the need for generators that pollute the air with noise and gasoline.

The vehicles are environmentally friendly, eliminating the use of paper, glue and raw material used in many other forms of advertising.

The vehicles may be dropped off at any time day or night to run for, for example, eight hours without making any noise or the need of human attendance.

The vehicles have the ability to bring the “virtual reality world” into the “real world.”. They preferably are able to bring up web-pages or anything on the Internet that is suitable for public display.

Additional innovative, patentable features, advantages and objects of the present invention, including inter alia the vehicle adaption methodology, should also be clear from the following detailed description, taken in conjunction with the accompanying drawings, as well as the claims originally and subsequently presented.

### BRIEF DESCRIPTION OF DRAWINGS

Thus, for a further understanding of the nature and objects of the present invention, reference should be had to the following detailed description, taken in conjunction with the accompanying drawings, wherein:

FIG. 1 is a generalized, simplified, schematic view of the over-all satellite broadcasting version of the preferred, exemplary embodiment of the multi-point advertising system of the present invention, along with a generalized alternative version exemplifying an internet, land-based, broadcasting approach.

FIG. 2 is a side view of a first, preferred, exemplary embodiment of the to closed body, side video display vehicle in the form of a trailer used in the exemplary system of the present invention; while

FIG. 3 is an opposite side view of the video trailer embodiment of FIG. 2, similar to FIG. 2 but of the opposite side of the vehicle; and

FIG. 4 is a rear end view of the video vehicle embodiment of FIG. 2.

FIG. 5 is a generalized, schematic or simplified view of the interior components of the closed body, video trailer vehicle of FIGS. 1-4, showing inter alia the electronic and video components located within the closed body of the vehicle.

FIG. 6 is a side view of a second, alternative, exemplary embodiment of the closed body, side video display vehicle, in this case in the form of a motorized van used in an alternative system of the present invention, with the opposite side view being generally a mirror image thereof; while

FIG. 7 is a rear view of the video van embodiment of FIG. 6.

FIG. 8 is a side view of a third, alternative, exemplary embodiment of the closed body, side video display vehicle, in this case in the form of a truck used in a further alternative system of the present invention, with the opposite side view being generally a mirror image thereof; while

FIG. 9 is a rear view of the video truck embodiment of FIG. 8.

FIG. 10 is a simplified view of an exemplary rear projection TV mounted on a wheeled dolly for easy movement of the TV on and off the vehicle.

### EXEMPLARY MODES FOR CARRYING OUT THE INVENTION

Drawing Reference Numbering

For convenience in referencing the drawings, the reference numbering scheme used herein is presented below:

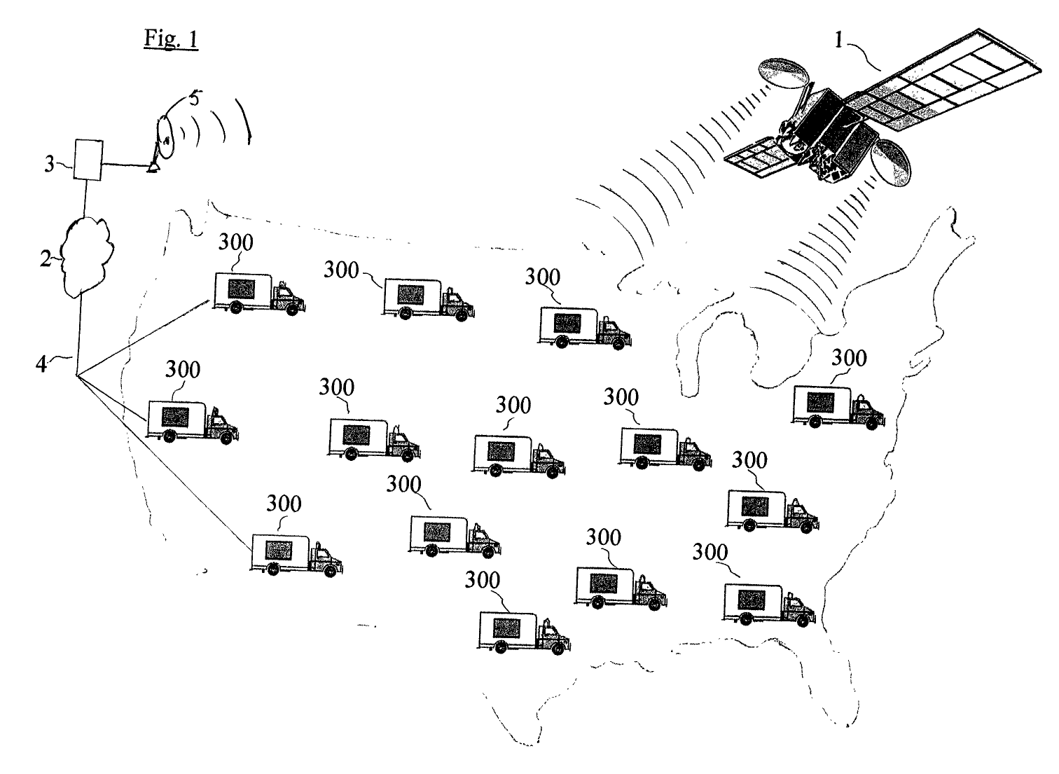

FIG. 1

satellite broadcaster 1

internet 2

internet server for advertising images/info 3

internet telecommunication lines 4

uplink satellite antenna 5

side display video trucks 300

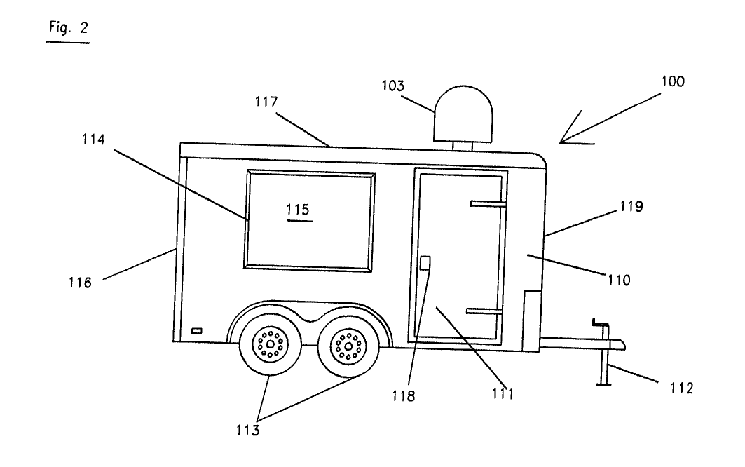

FIG. 2-4

pullable trailer (1^{st} exemplary vehicle approach) 100

enclosed body 101

satellite antenna 103

promotional signage 109

side wall panel 110

lockable side, entry door 111

adjustable front support 112

side wheels 113

side panel cut-out 114

side video display screen 115

rear of trailer 116

top of trailer 117

side door lock 118

front of trailer 119

vehicle lights 120

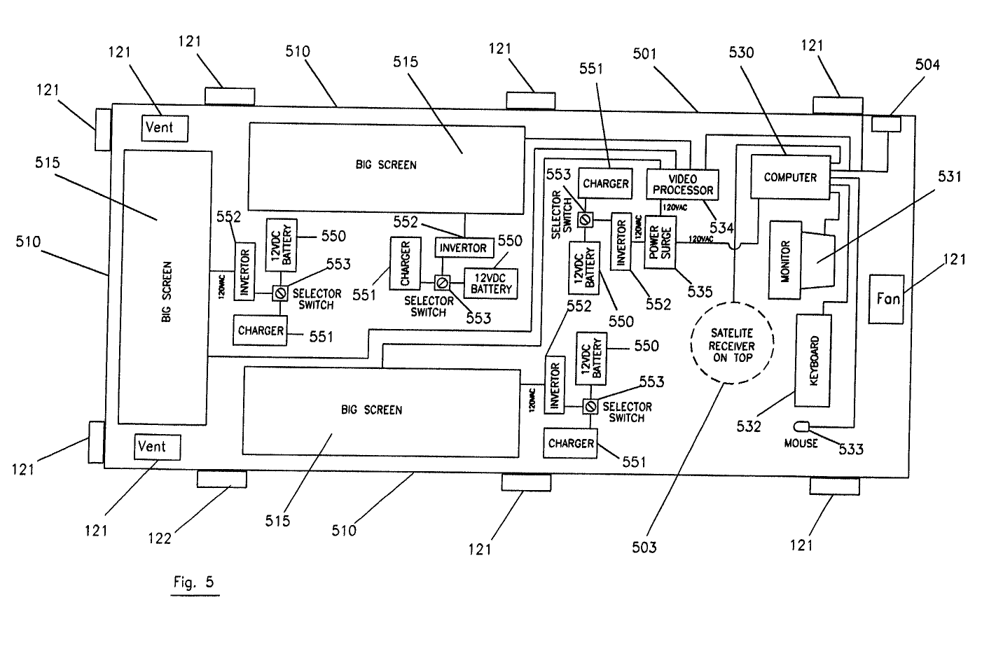

air cooling venting elements 121 (FIG. 5)

audio speakers 122 (FIG. 5)

ventilation fan 123 (FIG. 5)

FIG. 5

enclosed body 501

satellite antenna 503

alternate internet line connector 504

vehicle side panels 510

video rear projectors 515

vehicle rear panel 516

vehicle front panel 519

computer 530

computer monitor 531

computer keyboard 532

computer mouse 533

video processor 534

UPS-power surge unit 535

battery 550

charger 551

invertor 552

selector switch 553

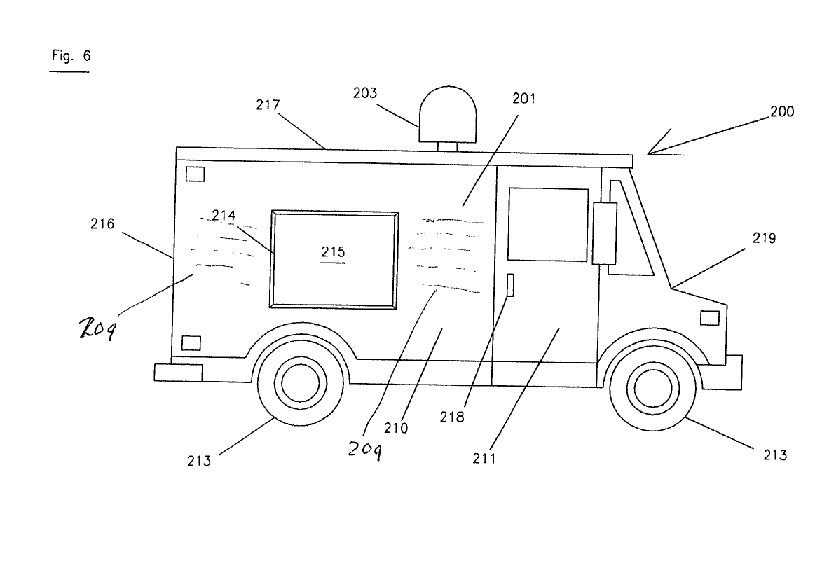

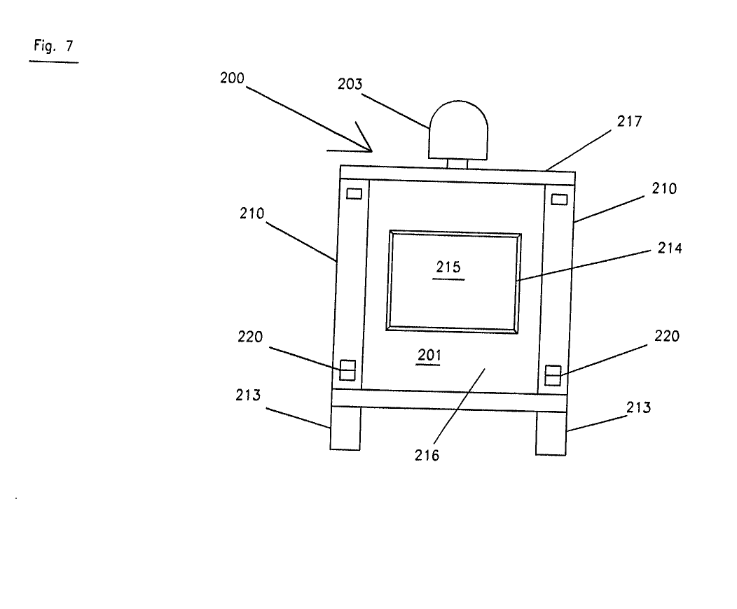

FIG. 6 & 7

motorized van (2^{nd} exemplary vehicle approach) 200

enclosed body 201

satellite antenna 203

promotional signage 209

side wall panel 210

lockable side, entry door 211

adjustable front support 212

side wheels 213

side panel cut-out 214

side video display screen 215

rear of van 216

top of van 217

side door lock 218

cab of van 219

vehicle lights 220

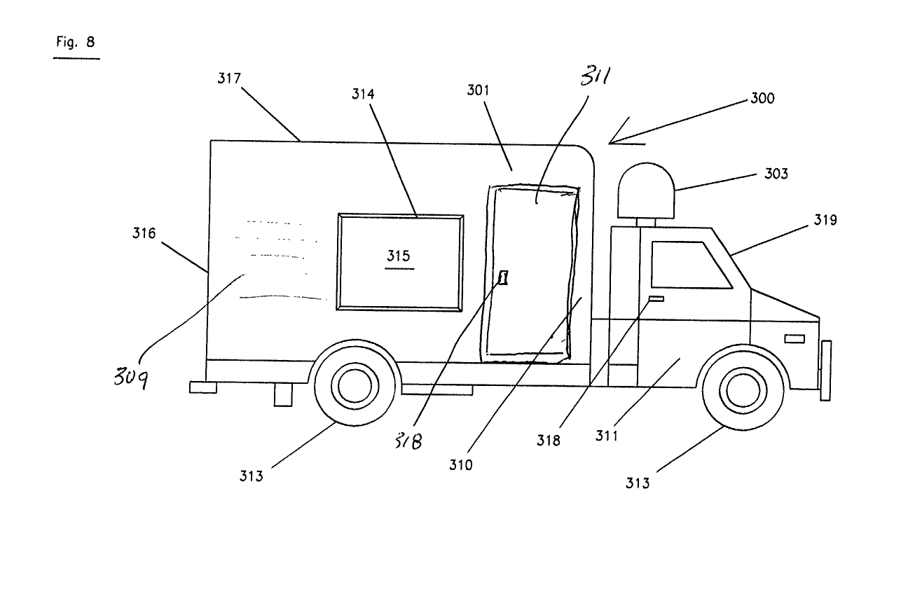

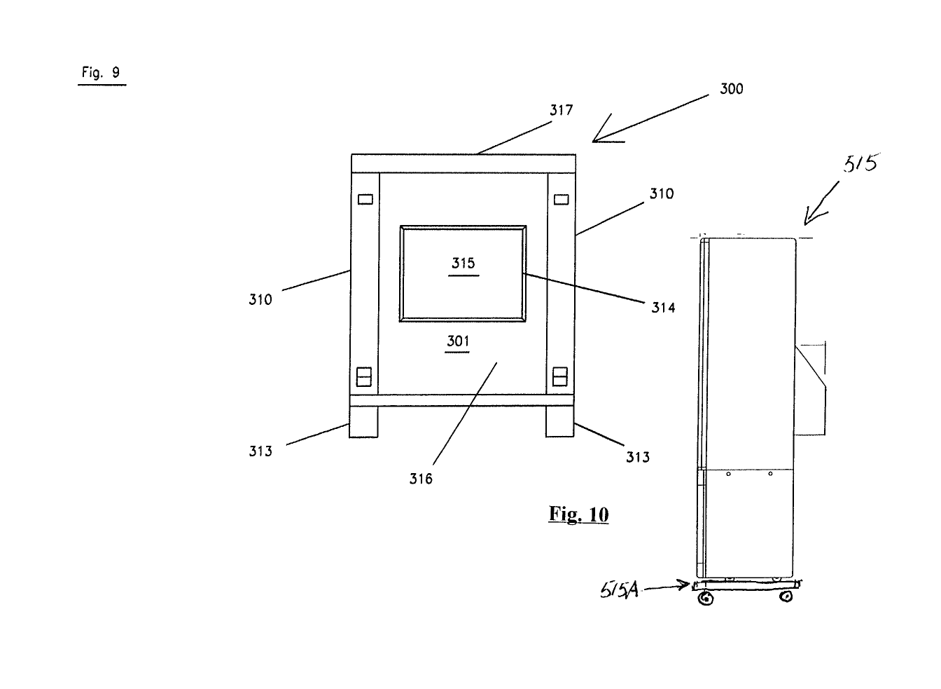

FIG. 8 & 9

truck (3^{rd} exemplary vehicle approach) 300

enclosed body 301

satellite antenna 303

promotional signage 309

side wall panel 310

body side, lockable entry door 311

cab side door 311A

adjustable front support 312

side wheels 313

side panel cut-out 314

side video display screen 315

rear of trailer 316

top of truck 317

side door lock 318

cab of truck 319

vehicle lights 320

FIG. 10

rear projection TV 515

wheeled dolly 515A

Over All System (Satellite/Land-Based; FIG. 1)

With reference to FIG. 1, the currently preferred, exemplary embodiment of the overall dynamic video display or advertising system of the present invention includes a series of video display vehicles, e.g., trucks 300, each of which has a video display screen on at least one of its sides or end, preferably on at least both sides and possibly also the rear end, of the vehicle for displaying computer generated or driven, dynamic video signals. Sending the video signals to the trucks 300 is a satellite 1 in space, typically on a geo-synchronous or stationary orbit above the earth.

As is known, the satellite 1 typically receives an incoming, corresponding video signal from an uplink, land-based site 3 including or associated with, for example, an internet server containing, for example, advertising images or other video information. The server 3 has, for example, the video signal recorded on suitable media for satellite broadcasting when desired via a satellite antenna 5, in a manner well known in the satellite transmission art.

The ultimate source of the video signal alternatively could come via the “Internet” 2, that is, the world-wide, global network, connected to the vehicles 300 via and-based telecommunication lines 4. The vehicles 300 can be connected to the Internet via land-based telephonic communication links using modems (e.g., 56K modems or broadband connections) in the vehicles or using a wireless telecommunications link using, for example, cellular or digital technology.

This allows two way communications via the Internet 2 and, for example, interconnection wiring 4 between the vehicles 300 and the server 3, or, alternatively, upload communications from the vehicles 300 via the telecommunications wiring 4 to the Internet 2 and the server 3 and download communications via the satellite 1 from the server uplink 3 to the vehicles 300. Such service is currently readily and widely available from Hughes Network Systems via its “direcPC”™ service (see www.direcpc.com).

If the satellite 1 allows for two-way communication, and the video source 3 is being transmitted directly to the satellite via, for example, the uplink satellite antenna 5, full, two-way, concurrent, co-ordinated communication between the truck(s) 300 and the ultimate video source 3 can be used. Such two way satellite communications, using a satellite communications dish antenna 103/203/303/503 (FIGS. 2,5, 6 & 8) on the vehicles 300, directly communicating with the satellite 1, provides the currently most preferred approach of the present invention. Such technology is becoming available from, for example, StarBand Communications, Inc. (see www.starband.com), Sky Global Networks, Inc. and soon Hughes Network Systems, etc.

The video server 3 effectively can be located anywhere, in one part of the country, for example, in Seattle, Wash., while the trucks 300 are spread elsewhere, for example, as generally illustrated in FIG. 1, throughout the country, from the east coast to the west coast and from the Canadian border to the Mexican border and along lid the Gulf of Mexico, or, alternatively, on an international basis. Typically, the video server 3 will be at least a number of miles away and more typically at least hundreds or thousands of miles away from the various video display vehicles 300 communicating with the server or at least receiving the video signal from the server.

It is also noted that the video signals being sent from the server 3 are in digital (vs. analog) format, that is, the signals are made up of a sequence of “1s” and “0s” or “on/off” bits, and the video signals stay in digital format all the way through their reception by the video display vehicle(s) 300 (except if and where a modem is used in the “chain” of communications). This, of course, is different in kind from standard, NTSC, through-the-air, broadcast TV or radio signals. When the satellite video signal reaches the trucks 300, the video signals are either stored on site in the vehicle on suitable storage media, e.g., a hard disk drive or supplemental storage devices, for later display or, alternatively and more preferably, for being concurrently displayed on the video displays 115/215/315/515 (FIGS. 2, 5, 6 & 8) of each of the vehicles or in selected ones of the vehicles 300, as may be desired.

It thus should be understood that the preferred embodiment of the system of the present inventions allows for concurrent, simultaneous broadcasting of live or dynamic video, that is, images or graphics, still (but changeable) or moving, to multiple, spaced locations as part of a coordinated advertising or other type of campaign, whether commercial or political or pro bono publico or otherwise. Thus, for example, a political speech could be simul-cast to a number of vehicles 300 for viewing by observers at many different locations across a desired area, e.g., internationally, the country, a state, regionally, a city or a community, etc., while the observers are away from traditional video displays, such as, for example, their home TVs, for example, while the observers are at playgrounds, shopping malls, sports locations, etc. This is particularly valuable where the video display vehicle(s) location(s) is/are in high intensity traffic area(s).

The displaying and viewing can be done on a local, regional, national or even international, coordinated basis, depending on the number and locations of the video display vehicles 300. Thus, the preferred embodiment can greatly enhance the viewability, that is, the potential audience of any video signal, as well as the flexibility of the signals to be displayed.

Thus, for example, the viewing public is given the opportunity to go to various types of gatherings while still being able to avail themselves of video viewing.

The same principles could be applied to commercial advertising campaigns where, for example, the advertiser wishes to, for example, make a concurrent announcement of some commercial event or sale of some value and interest, as well as for displaying general commercial advertising images.

It is contemplated that the video display vehicles 300 can be either sold outright to the end purveyor of the video images or to advertising businesses, etc., or leased or set up on a franchise basis. Thus, for example, an advertiser could engage on a rental basis, for example, a few, say, for example, five, or, for a larger campaign, one hundred and fifty (150) or even thousands of video display vehicles 300 and have them placed throughout a selected city or cities in, for example, a single state or multiple states, etc., for a coordinated, controlled campaign in the selected area(s). By their very nature, the vehicles 300 can be readily driven and located where desired and then quickly and easily deployed to new location(s) and so on, magnifying their advertising effectiveness and worth.

The foregoing examples are, of course, subject to great variation.

Trailer Vehicle (FIGS. 2-4)

With reference to FIGS. 2-4, an exemplary video display vehicle 100 of a pullable trailer type is illustrated. As can be seen, the vehicle 100 includes an enclosed trailer body 101, having on its top 117 a preferably two-way, satellite antenna 103 for communicating with the satellite 1 and receiving video signals from the ultimate video source 3 via the satellite 1. The body 101 has two side panels 110, at least one of which has a lockable, side entry door 111 located adjacent to the video display screen 115 (note FIG. 2) for entry into the body and access to its contents detailed, for example, in connection with FIG. 5 below. A side door lock 118 is included for security purposes.

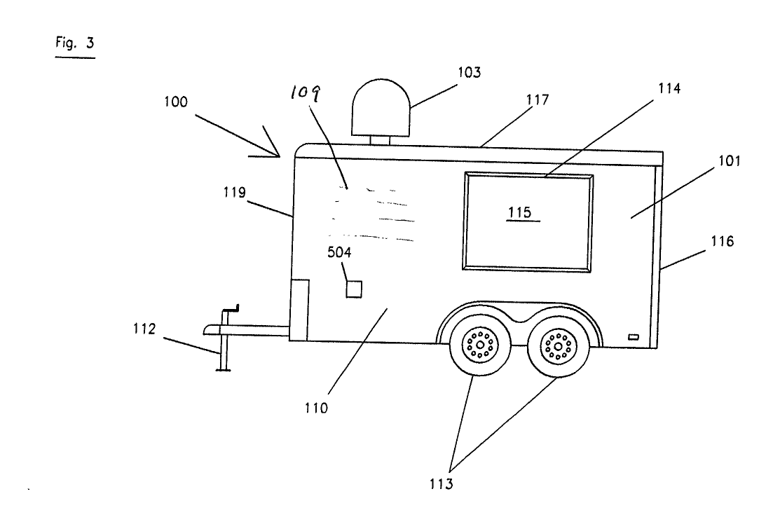

The side that does not have the door 111 provides a relatively large, “free” area adjacent to the video display screen 115 (particularly to the left, as viewed in FIG. 3) preferably used for signage 109 promoting, for example, the use of the vehicle for video display of prospective customers' video messages. Thus, the sign might read, for example, “CALL 555-5555 to RENT THIS VEHICLE!”

As typical of trailers an adjustable front support 112 is provided on the front 119 of the trailer 100, which has sets of side wheels 113. On at least one side and preferably both sides there is provided a side panel cut-out 114 through which a side video display screen 115 is seen, preferably with a single video display screen per side.

The rear 116 of the trailer 100 likewise includes a panel cut-out 114 through which an end video display screen 115 is viewed, resulting in viewable display screens on three sides of the vehicle. The front of trailer 119 also can include a panel cut-out (114) through which a front video display screen 115 can be seen or viewed, if so desired, for maximum viewable displays, although typically for the preferred types of vehicle the front display screen will be smaller than the side or rear displays. This would be particularly advantageous if the trailer 100 is brought to a location for viewing and parked at that location for a desired period of time, ranging from a few hours to a number of days, etc. If so desired, the front area of the body 101 could be enlarged to accommodate a larger video screen.

With a standard vehicle 100 (200/300) being used and having at least their side and possibly rear and front panel(s) cut out, it is desirable to include wall stiffening structures to beef up the wall panels using, for example, appropriately cut, plywood sections or supplemental support beams. The cut-outs (114) are sized to equal the size of the video display screen 115 to be used, for example, rectangular cut-outs each having, for example, a sixty or sixty-five inch (60″ or 65″ measured on the diagonal) cut-out measured diagonally in, for example, the current analog TV NTSC screen U.S. standard four-to-three (4:3) ratio. A video display screen (115) is then positioned in or behind each cut-out for display and viewing purposes. Of course, other screen ratios are possible, including, for further example, the U.S. standard SDTV and HDTV screen size having a ratio of sixteen-to-nine (16:9).

When a dolly (515A, note FIG. 10) mounted, rear projection TV 515 set is used for the video display 115, it is rolled into place and appropriately positioned with its screen co-existent with its respective cut-out 114 and fastened into position, with the vehicle 100 (200/300) brought to its desired location or driven along its desired route for viewing by people at that location or along that route. When the viewing is complete, the vehicle 100 (200/300) is then moved to a different location or along a different route for the display or viewing of the same or a different video signal. When the use of the vehicle 100 (200/300) is complete, it can be returned to its central storage location, and, if so desired, the dolly-mounted, rear projection TVs 515 are unfastened, and rolled off of the vehicle for, for example, off-vehicle storage or maintenance.

To provide sound or audio accompanying the video display, audio speakers 122 are provided on the trailer 100 in connection with each video display screens 115. As shown in FIG. 5, three speakers 122 are provided, including a center channel and two, flanking, left/right speakers, which can be used to provide spatial audio imaging. Two or more additional speakers (122) could be provided for satellite” speakers to provide, for example, “Dolby Digital”™ 5.1 or “DTS”™ sound, etc.

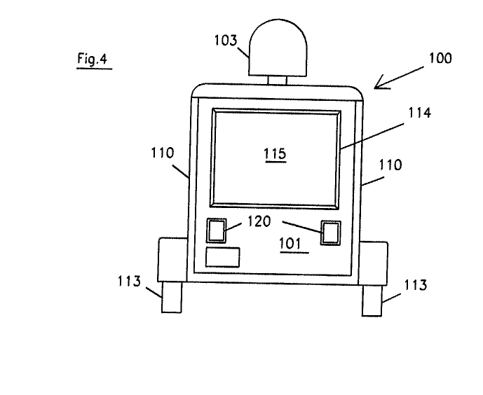

As can be seen in FIG. 4, the vehicle 100 includes standard, vehicle tail lights 120. Air cooling venting elements 121 (note FIG. 5) are included in the top 117, as well as possibly elsewhere, as needed or desired for venting the heat produced inter alia by the substantial amount of electronic equipment contained within the trailer body 101.

The satellite antenna 103 could be either static or dynamic in its directionality, which in the latter case is achieved by a antenna drive which stays pointed at the satellite 1 as the vehicle 100 is moved about on its wheels 113. Some exemplary antenna equipment that could be used include the “Gemini Earth Station,” the to “DirecWay”™ multimedia VSAT or Enterprise Edition from Hughes Network Systems, “TracVision”® LM from KVH which has dynamic satellite tracking for a vehicle and the KVH “TracVision”® G$ which privides an in-motion, marine satellite TV antenna system, personal earth station (PEM™) 5000 Plus, etc.

Exemplary Electronic Equipment (FIG. 5)

As can be seen in FIG. 5, the exemplary electronic equipment contained in the vehicle body 501 (101/201/301) includes a satellite antenna 503 (103/203/303), preferably having two way communications capabilities or at least down load or down link capability for receiving video data from the satellite 1 which then is stored or otherwise processed in the computer 530. As an alternative telecommunication link for at least up-linking to the Internet 2, an alternate, internet line connector 504 from the computer modem (not illustrated but well known) is included for hard wire connection to the Internet in coordination with the downlink from the satellite 1. If satellite communication is not available, the line connector 504 can be used for two way communication, if so desired, using, for example, a 56K modem or, for greater broadband capacity, a cable modem, xDSL or T₁ line, if available.

Additionally or alternatively, wireless telecommunications, using for example a cellular or digital phone, can be used for either a coordinated uplink to the Internet 2 or for two way telecommunications with the Internet using currently available technology. Although current telecommunications speeds, particularly for wireless telecommunications, is relatively slow for downloading video, effective data streaming rates are increasing as time goes by.

In comparison to a hard wired link, wireless allows for mobile telecommunications during the vehicle's movement and is currently preferred for vehicles which are intended to .to display for public viewing while in transit, although, as previously stated, two way satellite communications is the most preferred for mobile display. Of course, if the video information is effectively pre-loaded on the computer 530 using its hard drive(s) or using video compact disks (CDs), digital versatile disks (DVDs), laser disks, VHS video tapes and the like, the vehicle can display video images on the side and rear video display screens 515 when in transit using the video data already available from the computer 530 or an equivalent video playback system (video receiver, video CD player, DVD player, laser disk player and/or VHS tape player, etc.).

In analogous fashion to vehicle 100, vehicle side and rear panels 510/516, respectively, allow the three, internal, video rear projectors 515 or other appropriate video displays to be seen by the public located in the area surrounding the vehicle.

The computer 530 preferably includes a computer monitor 531, computer keyboard 532, a computer mouse 533, and an associated video processor 534. A UPS power surge unit 535 is provided to protect the associated electronic equipment, including the computer system 530-534.

Each big screen, rear projector TV 515 and the computer system 530-534 preferably includes a battery 550 (e.g., a standard, readily available, 12 volt DC battery of the marine type, such as, for example, a “GEL TECH” Model No. 8G8D group 8D 12 volt gel battery), a charger 551, an invertor 552 and a selector switch 553. An alternative, more preferred battery 550 is a BCI “LIFELINE GD” type battery (8d 255-8d-12), which produces when new about two hundred and fifty-five (255) amp hours of DC electrical power.

Either of these exemplary batteries for the battery 550, producing two hundred and twenty-five (225) or two hundred and fifty-five (255) amp hours, respectively, provides suitable power to the video display units and the associated micro-computer system 530-534 for an extended period of time (e.g., about six hours or eight hours or more) for displaying video displays while the vehicle is in transit or otherwise in motion or at a location where no AC power is available. A battery producing when new a minimum of about two hundred (200) amp hours is considered necessary for appropriate battery power for the complete electronics of FIG. 5. When parked, the vehicle preferably is connected up to an AC power line, which charges up the batteries 550 via the chargers 551 and which can be used to power the equipment when used for stationary display for effectively an unlimited time.

An exemplary, big screen, rear projector TV 515 is a Zenith sixty (60″) inch projection TV (model #Z60Z83). Each rear projector TV 515 (as well as preferably the computer system) preferably is mounted on a wheeled platform or dolly (note FIG. 10) to allow them to be quickly and easily rolled on and off the vehicle body 501 (101/201/301). Because each such TV includes a lot of tuner related receiver circuitry which is unnecessary to the invention, a monitor type, video display could be used to achieve the purposes of the present invention.

For example, gas plasma monitors could be used, such as, for example, those from Fujitsu, NEC (e.g., its model NP50C1MF01), Pioneer (e.g., its model PDP-505HD), Sony, etc., which can provide HDTV video displays in a very compact, relatively flat package. As a further alternative, liquid crystal display (LCDs) monitor panels could be used. However, due to price considerations and reduced pricing of 4:6 screen ratio TVs, full, rear projection TVs currently are more cost effective. However, with time, for example, the technically preferred gas plasma screens are expected to be more cost effective.

When the video display is in the form of a flat panel, the flat panel display can be mounted, if so desired, on the exterior of the side walls 110, obviating the need for cutting out a section of the side wall panel for the cut out 114, as described above. This is considered an equivalent approach.

A ventilation fan 123 preferably is included in connection with vents 121 to vent the vehicle interior and reduce the interior temperature in the vehicle. If so desired, alternatively, the interior of the vehicle could be air conditioned.

Vehicle Variants (FIGS. 6 & 7 and 8 & 9)

It is noted that alternative, video display vehicle designs or types, namely, van 200 & truck 300 with enclosed bodies 201 & 301, are illustrated in FIGS. 6 & 7 and 8 & 9, respectively. Because of the analogousness of these vehicles with the video display vehicle 100 described in detailed above and the identification of the reference numbers of these figures above, further description would be considered superfluous and redundant. In the interest of brevity, general reference is made to the foregoing descriptions.

It is noted that all three, exemplary vehicle types, that is, the pullable, closed body trailer 100, the van 200 and the closed body truck 300 are relatively inexpensive and easily adaptable to be used in the system of the present invention and are relatively short bodied, for example, less than about twelve (12′) feet in body length. By merely cutting rectangular holes in the side (110/210/310/510) and/or rear (116/216/316/516) and/or front (119/219/319/519) panels and adding any structural beefing up necessary to compensate for the loss in structural strength due to the panel cut-outs, and adding the appropriate electronic equipment (FIG. 5), the video display vehicles of the invention are easily and economical made.

In fact, the total cost of a prototype of a vehicle comparable to the closed body truck 300 of FIGS. 8 & 9 with the electronic equipment illustrated in FIG. 5, including the three video displays 315, only about thirty-five thousand ($35,000.00) dollars. As the vehicles are produced on a volume basis, economies of scale and reductions in rear projection TVs and other video displays will allow an even less cost. Also, it is noted that the non-motorized, trailer vehicle 100 of FIGS. 2-4 would be substantially less.

It is further noted that preferably no significant, if any, gaps between the video display screens 115/215/315/515 and the remaining vehicle walls 110/210/310/510 & 116/216/316/516, provide reasonable security, even allowing a vehicle operator to position the vehicle, start-up the equipment to display the desired video signals, and even leave the vehicle for, for example, a lunch break or the like, with the standard vehicle doors 111/211/311 locked, thereby still maintaining reasonable security from theft. Also, with operation allowed with all doors closed, adverse weather conditions that might damage the electronic equipment illustrated in FIG. 5 is avoided.

Exemplary vehicles for the three types of vehicles 100, 200 & 300, respectively, are:

1. a pullable trailer 100—for example, a “PACE” cargo trailer with an enclosed body size of about twelve foot (length) by six foot (width) by six and a half foot (height), namely, about 12′×6′×6.5′;

2. a van 200—for example, a “GMC” step van or a “UTILIMASTER” walk-in or step van having an enclosed body size of about twelve foot (length) by six and a half foot (width) by a little over six foot (height) or greater, namely, about 12′×6.5′×6′+; and

3. a closed body truck 300—for example, a “GMC Savana” cutaway truck or van or other enclosed body on, for example, a “GMC P-Chassis” (or for heavier load carrying capacity a “T-Series” or “W-Series” chassis) or a “Ford E-Series” chassis, having an enclosed body size of, for example, about twelve foot (length) by about seven foot (width) by about six and a half foot (height); namely, about 12′×7′×6.5′; with a greater height body being desirable if a front video display is desired.

Thus, in each instance, the size of the vehicle body 101/201/301 is typically and preferably relatively small, that is, less than about twelve (length) by about six foot (width) by about six and a half foot (height) or greater for front video display, that is about 12′×6′×6.5′+. Considering the size of a side panel, that is, about twelve foot by about six and a half foot (12′×6.5′ for a total of about 78 square feet), a single, sixty (60″ on the diagonal, 4:3 ratio, total 12 square feet) inch video projection TV screen takes up about a little over fifteen (15+%) percent of the total side surface area of the main enclosed body.

Exemplary, approximate screen sizes and their approximate relative area percentages, using exemplary rear projection Mitsubishi rear projection TVs as examples, are outlined below.

| Model # | Screen Size | Ratio | Screen Area | % of Side |
|---|---|---|---|---|
| VS-50707 | 50″ dia. | 4:3 | 3.33′ × 2.5′ | 10.7% |
| | | | (8.3 #′) | |
| VS-55707 | 55″ dia. | 4:3 | 3.67′ × 2.75′ | 12.9% |
| | | | (10.1#′) | |
| VS-60707 | 60″ dia. | 4:3 | 4′ × 3′ | 15.4% |
| | | | (12#′) | |
| VS-70707 | 70″ dia. | 4:3 | 4.67′ × 3.5′ | 21% |
| | | | (16.35#′) | |
| WS-55907 | 55″ dia. | 16:9 | 4′ × 2.25′ | 11.5% |
| | | | (9#′) | |
| WS-65907 | 65″ dia. | 16:9 | 4.71′ × 2.65′ | 16% |
| | | | (12.5#′) | |
| WS-73907 | 73″ dia. | 16:9 | 5.33′ × 3′ | 20.5% |
| | | | (16#′) | |

where “% of Side” refers to the percentage of the video display screen area in square feet to the total square footage area of the typical side wall 111/211/311 of the main vehicle body 101/201/301, which side panel measures, for example, 12′×6.5′ for a square footage area of seventy-eight (78#′) square feet.

Thus, the preferred percentage range of the screen area of the side video display 115/215/315 relative to the side wall panel 111/211/311 is from about ten (10%) percent to about twenty-one (21%) percent or greater, with there preferably being only one video display screen per side. A particularly preferred embodiment is a percentage of about fifteen to sixteen (15-16%) percent or greater, that is, at least about fifteen (15%) percent.

It should be understood that the foregoing variations and alternatives, etc., are merely exemplary and many other changes are possible within the teachings of the present invention.

It is noted that the embodiments of the present invention described herein in detail for exemplary purposes are of course subject to many different variations in structure, design, application and methodology. Because many varying and different embodiments may be made within the scope of the inventive concept(s) herein taught, and because many modifications may be made in the embodiments herein detailed in accordance with the descriptive requirements of the law, it is to be understood that the details herein generally are to be interpreted as illustrative and not in a limiting sense.

What is claimed is:

1. A method of providing a concurrent, co-ordinated, video display at a number of separate, substantially spaced locations, with at least some of the locations being spaced apart at least a number of miles, comprising the following steps:
a) using a number of multiple, wheeled vehicles,
each having a closed body having four side walls—one on each side, a front and a real wall, and a roof, all interconnected together to form the closed body of the vehicle,
with each vehicle having a lockable door leading into the closed body,
with each vehicle having a satellite antenna capable of receiving video signals from a space-based, geo-synchronous satellite digitally communicating with a land-based video server, along with associated electronic equipment located inside the closed body, and
with each vehicle having at least one video display located adjacent to at least one side wall of the vehicle viewable from the exterior of the vehicle through the one side walls of the closed body;
b) moving on their own wheels the video display wheeled vehicles to the substantially spaced locations; and
c) thereafter concurrently displaying on the vehicle video display screens of the substantially spaced vehicles the same video signal emanating from the satellite from the land-based video server to viewers located on the exterior of the vehicles.

2. The multi-point, vehicular video display method of claim 1, wherein at least some of the vehicles are closed body trailers which are designed to be pulled by another, motorized vehicle and wherein there is an operator for the electronic equipment with respect to each of the vehicles, and wherein there is further included the steps of:
b-1) moving the trailers to their respective locations by means of another motorized vehicle;
b-2) setting up the electronic equipment via the respective vehicle's operator to cause the video signal received from the satellite through the vehicle satellite antenna to be displayed on the vehicle's video display; and
b-3) leaving the moved trailers at their respective locations for a period of time while the respective operator is away from one or more of the trailers, during which time the respective lockable door is locked.

3. The multi-point, vehicular video display method of claim 1, wherein there is an operator for the electronic equipment with respect to each of the vehicles, and wherein there is further included the steps of:
b-1) setting up the electronic equipment via the respective vehicle's operator to cause the video signal received from the satellite through the vehicle satellite antenna to be displayed on the vehicle's video display; and
b-2) leaving the moved vehicles at their respective locations for a period of time while the respective operator is away from one or more of the vehicles, during which time the respective lockable door is locked.

4. The multi-point, vehicular video display method of claim 1, wherein, after steps “b” & “c” have been completed, there is further included the step of:
d) moving at least some of the vehicles to another locations and repeating step “c”.

5. The multi-point, vehicular video display method of claim 1, wherein, in connection with step “c,” there is further included the step of:
c-1) separately and independently sending out signals from each of the video display vehicle to effect subsequent transmission from the geo-synchronous satellite.

6. The multi-point, vehicular video display method of claim 5, wherein, in connection with at least some of the vehicles, there is further included, in connection with step “c-1”,″ the step of:
c-1a) sending the signals via the Internet.

7. The multi-point, vehicular video display method of claim 6, wherein there is further included, in connection with step “c-1a,” the step of:
c-1b) sending the signals via the Internet using a wireless connection from the vehicle to the Internet.

8. The multi-point, vehicular video display method of claim 6, wherein there is further included, in connection with step “c-1a”,″ the step of.
c-1b) sending the signals via the Internet using a hard-wired connection from the vehicle to the Internet.

9. The multi-point, vehicular video display method of claim 6, wherein there is further included, in connection with step “c-1a”,″ the step of:
c-1b) sending the signals via two-way communication via the satellite antenna with the geo-synchronous satellite.

10. A video display vehicle system, comprising:
a wheeled vehicle of the type from the group consisting of a closed body trailer, a closed body van and a closed body truck, said wheeled vehicle—
—having a closed body having four side walls—one on each side, a front wall and a rear wall, and a roof, all interconnected together to form said closed body of the vehicle, and having a lockable, entry door leading into said closed body;
a satellite antenna mounted on the vehicle and being capable of receiving video signals from a space-based, geo-synchronous satellite digitally communicating with a land-based video server, and associated electronic equipment connected to said antenna and located inside said closed body;
at least one video display screen located adjacent to one of said side walls of the vehicle viewable from the exterior of the vehicle through the one of said side walls of said closed body, said one of said side walls having a rectangular cut-out in its wall structure open to the interior of said closed body, said video display screen positioned against and aligned with said cut-out, said video display screen being the only display screen viewable on that one of said side walls.

12. The video display vehicle system of claim 10, wherein there is further included on said vehicle:
a connection to the Internet of the type from the group consisting of hard wired and wireless connections.

13. The video display vehicle system of claim 10, wherein there is further included in said closed body of said vehicle:
a micro-computer sub-system associated with said video display screen sending video signals to said video display screen.

14. The video display vehicle system of claim 13, wherein:
said computer sub-system includes a video source player of a video content source containing video signals from the group consisting of a CD player, a DVD player, a laser disk player and a video tape player, said video source player feeding the video signals from the content source to said video display screen displaying the video signals on said screen.

15. The video display vehicle system of claim 10, wherein there is further included in said vehicle:
at least one battery producing at least about two hundred amp hours, said battery being sufficient to power said video display screen and any needed associated electronic equipment for at least six (6) hours.

16. A method of making a video display vehicle system, comprising the following steps:
a) obtaining a wheeled vehicle of standard make from one of the established vehicle manufacturers and being one of the types from the group consisting of a closed body trailer, a closed body van and a closed body truck, said wheeled vehicle—
—having a closed body having four side walls—one on each side, a front wall and a rear wall, and a roof, all interconnected together to form said closed body of the vehicle, and having a lockable, entry door leading into said closed body;
b) cutting out a rectangular piece out of and completely through at least one of said side walls of a size substantially equal to the size of a standard, “off-the-shelf” video display screen, with the cut-out being open to the interior of said closed body, with the area defined by said cut-out being at least from a minimum of about ten (10%) percent of the total area of said one of said side walls to a maximum of about twenty-one (21%) percent of the total area of said one of said side walls; and
c) placing one such video display screen positioned against and aligned with said cut-out, said video display screen being the only display screen viewable on that one of said side walls.

17. The vehicular video display vehicle method of claim 16, wherein there is further included, in connection with step “b,” the step of:
b-1) cutting said cut-out so that it is about fifteen (15%) percent of the total area of said one of said side walls.

18. The vehicular video display vehicle method of claim 16, wherein there is further included, in connection with step “a,” the step of:
a-1) providing the lockable, entry door in said one of said side walls adjacent to said cut-out.

19. The vehicular video display vehicle method of claim 16, wherein there is further included the step of:
d) installing equipment on said vehicle making a connection to the Internet.

20. A video display vehicle system, comprising:
a wheeled vehicle being one of the types from the group consisting of a closed body trailer, a closed body van and a closed body truck, said wheeled vehicle—
—having a closed body having four side walls—one on each side, a front wall and a rear wall, and a roof, all interconnected together to form said closed body of the vehicle, and having a lockable, entry door leading into said closed body;
a connection to the Internet associated with said vehicle; and
at least one video display screen located adjacent to at least one side wall of the vehicle viewable from the exterior of the vehicle through the one of said side walls of said closed body, said one of said side walls having a rectangular cut-out in its wall structure open to the interior of said closed body, said video display screen positioned against and aligned with said cut-out, said video display displaying a dynamic video signal from a content source, said content source being a site associated with the Internet.

21. The video display vehicle system of claim 20, wherein:
said connection to the Internet is a wireless connection.

22. The video display vehicle system of claim 20, wherein:
said connection to the Internet is a satellite antenna mounted on the vehicle capable of receiving video signals from a space-based, geo-synchronous satellite digitally communicating with a land-based video server associated with the Internet; and
wherein there is further included:
associated electronic equipment connected to said antenna and said video display screen and located inside said closed body.

23. The video display vehicle system of claim 20, wherein there is further included in said closed body:
a micro-computer sub-system associated with said video display screen sending video signals to said video display screen.

24. The video display vehicle system of claim 23, wherein:
said computer sub-system includes a video source player of a video content source containing video signals from the group consisting of a CD player, a DVD player, a laser disk player and a video tape player, said video source player feeding the video signals from the content source to said video display screen displaying the video signals on said screen.

25. The video display vehicle system of claim 20, wherein:
said lockable, entry door is located in said one of said side walls adjacent to said video display screen.

26. The video display vehicle system of claim 20, wherein said vehicle further includes:
at least one battery producing at least about two hundred (200) amp hours, said battery being sufficient to power said video display screen and any needed associated electronic equipment for at least six (6) hours.

27. The video display vehicle system of claim 20, wherein said vehicle further includes:
at least two video display screens with separate cut-outs for each, one on each side of said vehicle.

28. The video display vehicle system of claim 27, wherein said vehicle further includes:
at least one additional video display screen located in a cut out in the rear wall of said vehicle.

29. A video display vehicle system, comprising:
a wheeled vehicle of standard make from an established vehicle manufacturer and being one of the types from the group consisting of a closed body trailer, a closed body van and a closed body truck, said wheeled vehicle—
—having a closed body having four side walls—one on each side, a front wall and a rear wall, and a roof, all interconnected together to form said closed body of the vehicle, and having a lockable, entry door leading into said closed body; and
at least one video display screen located adjacent to at least one side wall of the vehicle viewable from the exterior of the vehicle through the one of said side walls of said closed body, said one of said side walls having a rectangular cut-out in its wall structure open to the interior of said closed body, said video display screen positioned against and aligned with said cut-out, said video display screen being the only display screen located on that one of said side walls, the area defined by said cut-out being at least from a minimum of about ten (10%) percent of the total area of said one of said side walls.

30. The video display vehicle system of claim 29, wherein:
the area defined by said cut-out being at least about fifteen (15%) percent of the total area of said one of said side walls.

31. The video display vehicle system of claim 29, wherein:
the area defined by said cut-out being a maximum of about twenty-one (21%) percent of the total area of said one of said side walls.

32. The video display vehicle system of claim 29, wherein said vehicle further includes:
a connection to the Internet.

33. The video display vehicle system of claim 29, wherein:
said lockable, entry door is located in said one of said side walls adjacent to said video display screen.

34. The video display vehicle system of claim 29, wherein:
the area of said one of said side walls adjacent to said video display screen is occupied by signage advertising the use of said vehicle for video signal display.

35. A video display vehicle system, comprising:
a wheeled vehicle being one of the types from the group consisting of a closed body trailer, a closed body van and a closed body truck, said wheeled vehicle—
—having a closed body having four side walls—one on each side, a front wall and a rear wall, and a roof, all interconnected together to form said closed body of the vehicle, and having a lockable, entry door leading into said closed body;
at least one battery producing at least about two hundred (200) amp hours; and
at least one video display screen located adjacent to at least one side wall of the vehicle viewable from the exterior of the vehicle through the one of said side walls of said closed body, said one of said side walls having a rectangular cut-out in its wall structure open to the interior of said closed body, said video display screen positioned against and aligned with said cut-out, said video display displaying a dynamic video signal from a content source, said battery being electrically connected to said video display screen and being sufficient to power said video display screen and any needed associated electronic equipment for at least six (6) hours.

36. The video display vehicle system of claim 35, wherein there is further included in said closed body:
a micro-computer sub-system associated with said video display screen sending video signals to said video display screen, said computer sub-system being part of said associated electronic equipment.

37. The video display vehicle system of claim 36, wherein:
said computer sub-system includes a video source player of a video content source containing video signals from the group consisting of a CD player, a DVD player, a laser disk player and a video tape player, said video source player feeding the video signals from the content source to said video display screen displaying the video signals on said screen, said video source player also being part of said associated electronic equipment.
